(19) United States
(12) Patent Application Publication
(10) Pub. No.: US 2008/0306800 A1
(43) Pub. Date: Dec. 11, 2008

(54) Light path management system and method thereof

(76) Inventors: Pang-Yu Liu, Hsichih (TW); Sen-Ta Chan, Hsichih (TW)

Correspondence Address: BRUCE H. TROXELL, SUITE 1404, 5205 LEESBURG PIKE, FALLS CHURCH, VA, 22041, US

(21) Appl. No.: 11/907,955

(22) Filed: Oct. 18, 2007

(30) Foreign Application Priority Data
Jun. 6, 2007 (TW) 096120392

(51) Int. Cl. G05B 19/418

(52) U.S. Cl. 705/8

(57) ABSTRACT

A light path management system and method for displaying working status of a user and subordinates thereof on a screen with light notification determining by weighting the job priority and work load. Sequentially, it further synthesizes light notification from subordinate staff into the user's conclusive working status, and then displaying the conclusive working status for the user and the subordinate staff thereof in hierarchy order. The invention relating to the light path management system and method can be well adopted for providing administrative suggestions, enhancing operation efficiency and reducing management cost at work.

### BACKGROUND OF THE INVENTION

1. Field of the Invention

The present invention relates to a system and method for managing work status, more particularly to a light path management system and method thereof.

2. Description of Related Art

Most people usually can not manage a variety of administrative matters effectively in the daily life. They frequently fail to remember things when they are busy at works, more particular on the aspect of organization management; for example, a supervisor usually is unable to perfectly realize and manage the working status of their subordinates effectively.

Seeing the aforementioned condition, there are several prior arts relating to the adoption of technologies of computer and internet for assisting the organization management. One prior art is TW Publication 200709088 which discloses an intellectual management method, including providing a plurality of operation guidelines, and then formulating a project with a pending job list in accordance with the specific operation guidelines. The project has a plurality of job item details. Each of job items is assigned to an executor, and then saving the executable job item in a specific job folder, and sequentially let each executor to control and manage individual job item within the job folder.

The other prior art is TW Publication I265433 discloses a distance employment management system and method thereof which enables a company to manage the distance corporate resources through the internet communication environment. The system comprises the modules that are able to connect to the internet. Those modules include human resource management, project tracking management, information exchange, and supervision & control modules which enable the employers and the distance users to conduct the interactive communication and manage the corporate resources via the different modules through the internet; and moreover to effectively manage distance resources and achieve better project collaboration internally.

Another prior art is TW Publication 200604878 which disclose an office automation management system and method which combines the geographic information management and traditional office automation through the on-line communication environment that adopt maps or graphs to replace the traditional wording description. This prior art enables the users of client terminals to manage the on-line administration via the graphic interface platform which will be more visualized and direct for office automation management and easily for the users.

It is needless to say that computers or internet technologies will assist people to improve the working efficiency. Further, in order to integrate those advanced computer technology and internet system to help us enhance working efficiency, the claimed invention is disclosed.

### SUMMARY OF THE INVENTION

This invention integrates the functions of computer and internet management system which will help us consolidate massive information and provide proper suggestions at work. In addition, with well adoption, it will reduce the operation cost and enhance individual efficiency.

It is therefore a primary purpose of the claimed invention to provide a light path management system and method thereof for displaying user's working status as different light notification on a screen, which is determined by weighting the job priority and work load. Sequentially, it further synthesizes light notification from subordinates as the user's conclusive working status, and then display the user's and the subordinates' responsive light notification in hierarchy order for better management.

Another purpose of the invention is to provide correct instruction or the suggestions for a user by the adoption of a light path management system and method thereof, and then to improve operation efficiency and further to reduce the operation cost.

The invention relating to a light path management method comprises the following steps:

(1) browsing a user's light notification transmitted from a terminal to a data transmission module by login an operation management system via a network system; and
(2) counting the user's weight value in accordance with a job data and a predetermined algorithm by a light-counting module to access the job data saved in a database server, and further comparing the weight value with at least one predetermined threshold value to generate a quantitative value in response to the user's light notification, wherein the maximum value in quantitative value is set as the light-outputting value whereby the terminal displays the light in response to the light-outputting value for expressing the user's working status, and wherein the light is displayed in hierarchy order in accordance with the user's work load and job priority for providing suggestions to the user and for enhancing the operation efficiency and reducing operation cost.

In addition, the invention further relating to a light path management system comprises a database server for saving a plurality of user's job data; a data transmission module for providing a plurality of users to transmit data by the usage of a terminal between a network system and an operation system; a data saving module for providing a user and the subordinate staff to save the job data in the database server; a light counting module for calculating the user's weight value in accordance with the predetermined algorithm saved in the database server, and further comparing the user's weight value with at least one predetermined threshold value to generate a quantitative value and finally selecting the maximum value from the quantitative values as the light-outputting value whereby the terminal displays the light in response to the light-outputting value for expressing the user's working status, and wherein the light notification is displayed in accordance with the user's work load and job priority for providing suggestions to the user and for enhancing the operation efficiency and reducing operation cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The features of the invention believed to be novel and the elements characteristic of the invention are set forth with particularity in the appended claims. The figures are for illustration purposes only and are not drawn to scale which follows taken in conjunction with the accompanying drawings in which:

FIG. 1 is a functional diagram of a light path management system in accordance with the present invention.

FIG. 2 is a demonstration chart of light notification displaying a user's working status in accordance with the present invention.

FIG. 3 is a simplified origination chart with light notification displaying a user's working status in accordance with the present invention.

FIG. 4 is a flowchart of a light path management method in accordance with the present invention.

FIG. 5 is a flowchart for a method of generating light-outputting values in accordance with the present invention.

FIG. 6 is a demonstration chart of lighting path management presenting an urgent job required immediate supports from the supervisor unit and the subordinate staff in accordance with the present invention.

### DETAILED DESCRIPTION OF THE INVENTION

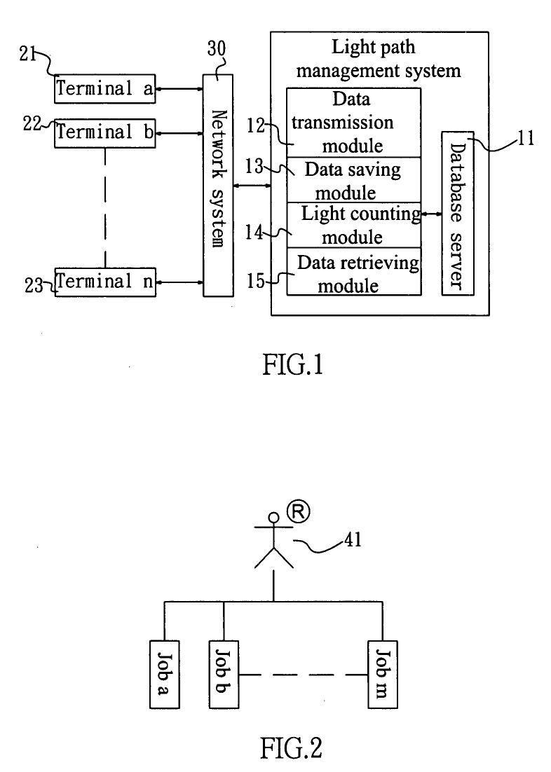

Referring to FIG. 1, which is a diagram of a light path management system in accordance with the present invention, comprising a database server 11 for saving identification, job data and lighting information of each user and subordinate staff thereof; a data transmission module 12 for providing a plurality of user to transmit data by the usage of the terminals a21, b22 and the like until the terminal n23 between a network system and an operation system; a data saving module 13 for providing a user and the subordinate staff to save individual identification, job data, and lighting information in the database server 11; a light counting module 14 for counting a weight value of a user and subordinate staff in accordance with the job data and the predetermined algorithm saved in the database server 11, and further comparing the weight value with at least one predetermined threshold value to generate the quantitative value, and finally select the maximum value from quantitative value as the light-outputting value whereby each of the terminals, including the terminal a 21, b22 and the like till terminal n23, displays the light in response to the light-outputting value for expressing the user's and the subordinates' working status; and a data retrieving module 15 for searching the light notification and the job data of the user and the subordinate staff in accordance with the searched criteria inputted by the user via an operation management system.

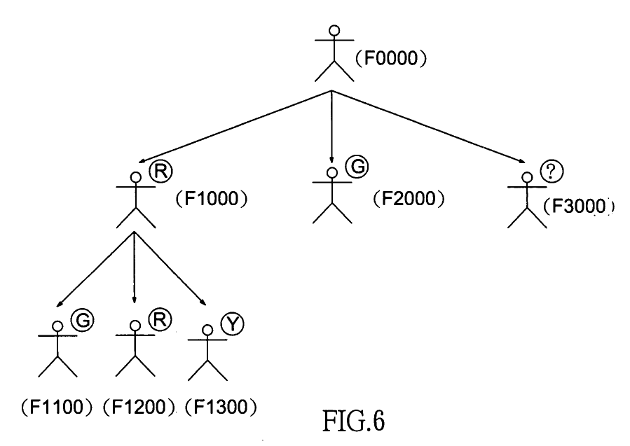

Referring to FIG. 2, which is a demonstration chart of light notification displaying a user's working status in accordance with the present invention. It automatically collects information relating daily job or the procedure of projects from a user 41, and then calculates the weight value of the user 41 in accordance with the job 1, job 2 . . . and job m, which the user 41 is responsible for, as well as the predetermined algorithm thereof, and sequentially comparing the weight value with at least one threshold value to generate the user's quantitative value which is set as the light-outputting value to display the responsive light on a screen, such as Red Light®. In addition, as presenting in the FIG. 6, if the user is a supervisor (F1000) who manages a plurality of co-workers or subordinates (F1100), (F1200), (F1300), these co-workers or subordinates (F1100), (F1200), (F1300) are regarded as the user's subordinate staff in which the latest light notification of the user will be determined after further synthesizing the subordinates' light notification. Sequentially, it utilizes the advanced webpage technology to display the light notification in hierarchy order, such that applying a light path management method for displaying the light notification of the supervisor and the subordinate staff in the meanwhile. As an example shown in the FIG. 6 that the invention is adopted by the supervisor to definitely realize the status of the organization, project procedure or plans, and easily find out the problems at work through the hierarchical light notification displayed on a screen. On the other hand, the user is able to differentiate each job priority with different light notification in order shown on personal own screen. If the light notification shows the red light, it means an urgent job required immediate supports. If the light notification shows the yellow light, it means a job required close observation. If the light notification shows the green light, it means a normal job. With the change, of the subordinates light notification, the user's light will be synthesizable changed accordingly. Thus, a light patch management method is valuable for an executor to effectively conduct administrative matters; moreover, to enhance operation efficiency in both management and at work.

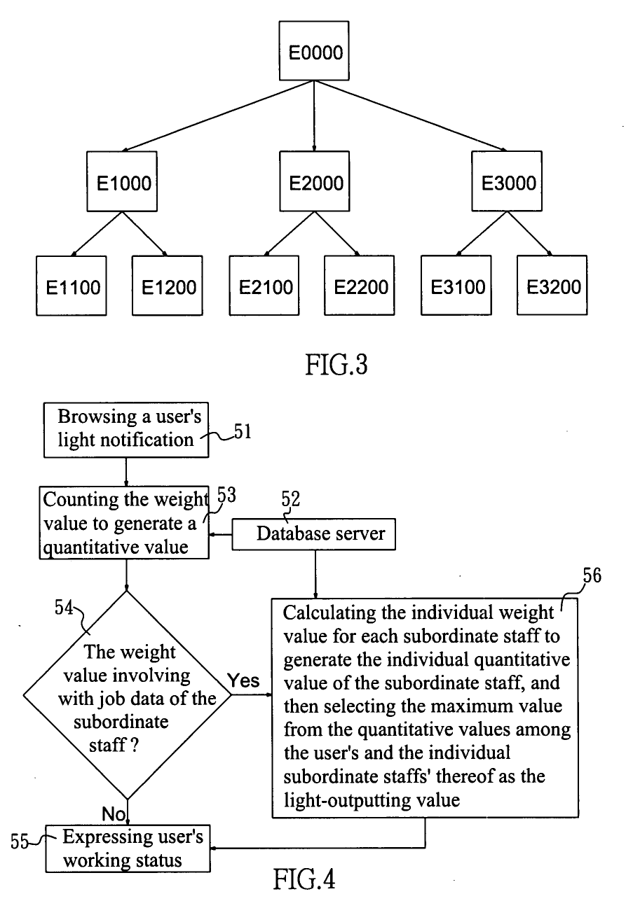

Referring to FIG. 3 which is a simplified organization chart with light notification displaying a user's working status in accordance with the present invention. The FIG. 3 shows that the top management level E0000 supervises three middle management levels E1000, E2000 and E3000, and each management unit E1000, E2000 and E3000 has the subordinate staff group in which E1100 and E1200 are supervised by E1000, E2100 and E2200 are supervised by E2000, and E3100 and E3200 are supervised by E3000. The light mark of each subordinate's light notification is determined in accordance with individual working status. Whenever the management level involves subordinates, the conclusive light notification for the management level and subordinates will be determined after further synthesizing with all the subordinate's light notification. For example, assuming the light notification of management unit E1000 as the middle management level is shown as green light at first. Furthermore, the subordinates E1100 and E1200 supervised by the middle management level E1000 shows the light notifications as the green light and the red light respectively. Sequentially, the conclusive light notification of E1000 should be synthesized from the light-outputting values of subordinate staff E1100 and E1200, wherein if the light-outputting value is set as the value for an urgent job with the expression of red light within one of the subordinates, the light notification of the middle management level E1000 will be conclusively displayed the red light in response to the urgent matter on a screen

Referring to the FIG. 1 and FIG. 4, which show a light path management method, comprises the following steps:

step 51: browsing a user's light notification transmitted from the terminals a21, b22, and the like till the terminal n23 to a data transmission module 12 by login an operation management system via a network system 30;
step 52 and 53: counting the weight value responsive to the user in accordance with the job data and the predetermined algorithm by a light counting module to access the job data and the identification responsive to the user saved in the database server 11, and further comparing the weight value with at least one predetermined threshold value to generate a quantitative value;
step 54: clarifying the weight value whether involving with job data of the subordinate staff;
step 55: if the weight value does not involve with the job data of subordinate staff, the light counting module 14 outputs the quantitative value as the light-outputting value, whereby the terminals a21, b22, and the like till the terminal n23 display the light mark in accordance with the light-outputting value for expressing the user's working status;
step 56: if the weight value involves with the job data of subordinate staff, calculating the individual weight value for each subordinate staff according to the predetermined algorithm, and further comparing the individual weight value of the subordinate staff with at least one predetermined threshold value to generate the individual quantitative value of the subordinate staff. Sequentially, selecting the maximum value from the quantitative values among the user's and the individual subordinates staffs' thereof as the light-outputting value, whereby the terminals a21, b22 and the like till the terminal n23 display the light mark responsive to the light-outputting value on a screen for expressing the user's working status and the subordinate staff working status.

The present invention utilizes the conception of aforementioned weight value to define the job priority, job data below,

Within the job data, comprising:
1. Job description means for describing the job description relating to each job between the user and the subordinate staff;
2. Job priority means for expressing the job with the priority in the order of P₁˜Pₙ; and
3. Job deadline means for expressing the over-due job that is automatically changed into the first priority job to do as Pₙ₊₁.

The present invention defines the meaning of light notification as follows:

The present invention defines three threshold vales as Wₓ, W_{y} and Wₓ to clarify the weight value, wherein Wₓ means of the highest value, W_{y} means of the middle value, and Wₓ means of the lowest value in response to the counted weight value by each user to clarify the light mark displayed on individual screen. Follows are four types of responsive light notification which generated according to the comparison between the aforementioned three threshold value and the individual weight value U_{w},
1. Red light means the value of U_{w} is greater than or is equal to Wₓ (U_{w}≧Wₓ) wherein Lᵣ as the quantitative value,
2. Yellow light means the value of U_{w} is less than Wₓ but great than or equal to W_{y}(Wₓ>U_{w}≧W_{y}) wherein L_{y} as the quantitative value;
3. Green light means the value of U_{w} is less than W_{y} but great than or equal to W_{z} (W_{y}>U_{w}≧W_{z}) wherein L_{g} as the quantitative value; and
4. Question mark means the value of U_{w} is less than W_{z} (W₂>U_{w}) wherein L_{q} as the quantitative value;
   wherein the question mark expresses that a user staying in idle mode which helps management level to effectively allocate work load and efficiently control the workforce.

In addition, the algorithm of calculating weight value in accordance with the present invention is divided user's job data into different levels of work load (C₁˜Cₙ₊₁) according to the priority (P₁˜Pₙ₊ₗ). Sequentially, adding up the multiplied result by C₁˜Cₙ₊₁ and the weight value W₁˜Wₙ₊₁ thereof as being the latest weight value. Then comparing the latest weight value with at least one predetermined threshold value to generates the quantitative value responsive to the latest weight value as the light-outputting value whereby the terminals display the responsive light to express the user's working status. If the job data of the user is involved with subordinate staffs' or the user is regarded as a supervisor to manage a plurality of subordinates, it is necessary to synthesize the quantitative values of the co-workers or subordinate staff, wherein the maximum value is selected from the quantitative values as the light-outputting value, and further whereby the terminal displays the working status of the user and subordinate staff in response to the light-outputting value.

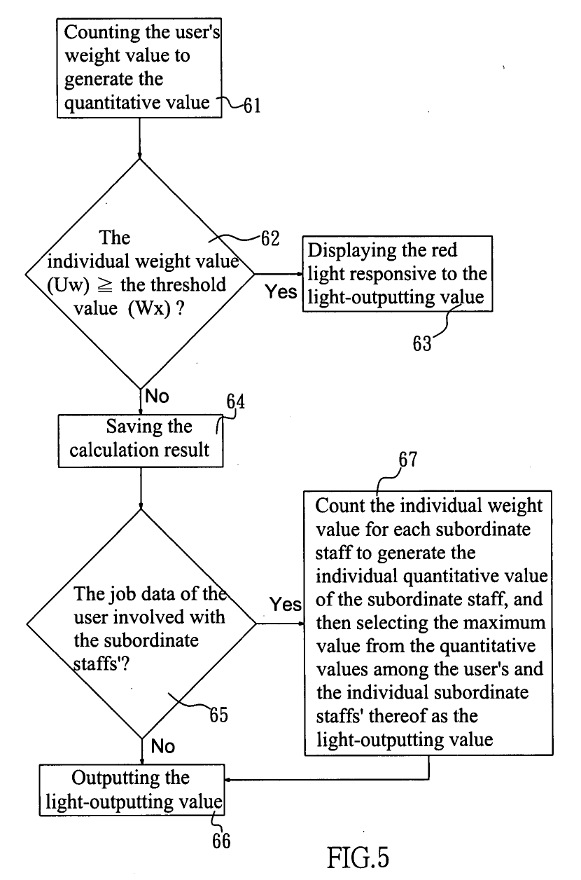

Referring to FIG. 5, which is a flowchart for a method of generating light-outputting values in accordance with the present invention, comprises the following steps:

Step 61: counting the user's weight value of U_{w} by the following formula in accordance with the user's job data to generate the quantitative value below: U_{w}=Σᵢ₌₁ⁿ⁺¹ Cᵢ*Wᵢ, wherein Cᵢ means the number of work load in response to priority Pᵢ; Wᵢ means the weight value in response to working priority Pᵢ; n means a natural number for expressing the number of jobs;
step 62: clarifying whether U_{w}≧Wₓ;
step 63: if U_{w}≧Wₓ, the quantitative value of Lᵤ is equal to Lᵣ whereby the terminal displays the first light as the red light responsive to the light-outputting value;
step 64: if U_{w}≧Wₓ is false, saving the calculation result;
step 65: clarifying whether the job data of the user is involved with the subordinate staff;
Step 66: if the job data of the user is not involved with the subordinate staffs', outputting the quantitative value Lᵤ as the light-outputting value whereby the terminal displays the light mark responsive to the light-outputting value; further, if the calculated result as Wₓ>U_{w}≧W_{y}, the quantitative value of Lᵤ is equal to L_{y} whereby the terminal displays the second light as the yellow light; if the calculated result as W_{y}>U_{w}≧W_{z}, the quantitative value of Lᵤ is equal to L_{g} whereby the terminal displays the third light as the green light; if the calculated result as W_{z}>U_{w}, the quantitative value of Lᵤ is equal to L_{q} whereby the terminal displays the fourth light as the question mark;
step 67: calculating the individual weight value of subordinates by the light counting module to access the job data saved in the database server in accordance with the predetermined algorithm responsive to the subordinates' job) data, and further comparing the subordinates weight value with at least one predetermined threshold value to generate individual quantitative value Lₛ₁, Lₛ₂ . . . Lₛₙ for each subordinate; sequentially, constituting an array responsive to the quantitative value {Lᵤ, Lₛ₁, Lₛ₂, . . . Lₛₙ} of the user and the subordinates thereof. Finally, the system will select the maximum value among the array L_{final}=max {Lᵤ, Lₛ₁, Lₛ₂, . . . , Lₛₙ} as the light-outputting value, wherein Wₓ, W_{y}, W_{z} presents the highest threshold value, the middle threshold value, and the lowest threshold value respectively. U_{w} means of the weight value of expressing the user's job data; Lᵤ means of expressing the user own quantitative value; Lₛ₁, Lₛ₂ . . . Lₛₙ mean of the quantitative values responsive to the user and the individual subordinates. If the job data of the user is involved with the subordinates', the light counting module outputs the consolidated light-outputting value whereby terminal displays the light mark responsive to the user and the subordinate staff thereof.

Referring to FIG. 6, which is a the demonstration chart of lighting path management presenting an urgent job required immediate supports from the supervisor unit and the subordinate staff in accordance with the present invention. It shows that a supervisor at the top management level (F0000) is able to realize the working status of subordinate staff and through the usage of the terminal to display working status of the user and the subordinate in hierarchy. Therefore, assuming the light mark of the top management level is shown as the red light, and the light marks of the middle management level F1000, F2000 and F3000 are respectively the red light the green light and the question mark respectively. Moreover, F1100, F1200, and F1300 as the other subordinates are supervised by the middle management level F1000 in which F1100 shows the light mark as the green light F1200 shows the light mark as the red light, and F1300 shows the light mark as the yellow light respectively. The top management level (F0000) can easily track whether there's red light among it's subordinates in middle management level F1000, F2000, F3000 when it discovers it's light is red. Further, the top management level can recognize the middle management level (F1000) and the subordinate (F1200) thereof require immediate supports. In addition, the top management level (F0000) is also able to recognize the middle management (F3000) in the idle mode.

The present invention integrates the functionality of a computer and a network management system thereof by the application of the light path management system and method that displays user's working status on a screen with function of lighting notification determining by weighting the job priority and work load. Sequentially, it synthesizes light notifications from subordinate staff into the user's latest working status, and then displaying the latest working status of the user and the subordinate staff thereof in hierarchy order. The invention relating to the light path management system and method can be well adopted for providing suggestions and reducing management cost at work.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light path management method, comprising:
browsing a user's light notification transmitted from a terminal to a data transmission module by login an operation management system via a network system; and
counting the user's weight value in accordance with a job data and a predetermined algorithm by a light-counting module to access the job data saved in a database server, and further comparing the weight value with at least one predetermined threshold value to generate a quantitative value in response to the user's light notification;
wherein a maximum value is selected from quantitative values as a light-outputting value whereby the terminal displays the light notification in response to the light-outputting value for expressing the user's working status; and
wherein the light notification responsive to the light-outputting value is displayed in accordance with the user's job priority.

2. The method of claim 1, wherein the job data means for comprising job data of the user and other subordinate staff thereof; the weight value means for comprising weight values of the user and subordinate staff thereof; the quantitative value means for comprising quantitative values of the user and subordinate staff thereof.

3. The method of claim 2, wherein the generation of the light-outputting value, comprising:
clarifying the weight value whether involving with the job data of subordinate staff; if the weight value does not involve with the job data of subordinate staff, the user's individual quantitative value is set as the light-outputting value; whereas, if the weight value involves with the job data of subordinate staff, calculating the individual weight value for each subordinate staff, and further comparing the individual weight value of the subordinate staff with at least one predetermined threshold value to generate the individual quantitative value of the subordinate staff, and then selecting the maximum value from the quantitative values among the user's and the individual subordinate staff's as the light-outputting value.

4. The method of claim 3, wherein the generation of the light-outputting value, prior to calculating the weight value of the subordinate staff, further comprising:
clarifying the user's weight value if more than a highest threshold value; if the weight value is more than the highest threshold value, the user's quantitative value is set as the light-outputting value without either calculating the weight value of the subordinate staff or processing further procedures; whereas, if the weight value is less than the highest threshold value, saving the user's quantitative value, and sequentially calculating the weight value of each subordinate staff and processing further procedures.

5. The method of claim 2, wherein the algorithm means for calculating the weight value set as Uw in accordance with to the following formula:
U_{w}=Σᵢ₌₁ⁿ⁺¹Cᵢ*Wᵢ, wherein the Cᵢ means of the number of work load in different priority; Wᵢ means of the weight value in different job priority; n means of a natural number for expressing the number of jobs.

6. The method of claim 5, wherein the generation of the quantitative value comprises the step of comparing the weight value of U_{w} with at least one threshold value to generate at least two alternatives of quantitative values.

7. The method of claim 6, wherein the generation of quantitative value comprises the comparisons between weight value of U_{w} and the highest threshold value of Wₓ, and the middle threshold value of W_{y} respectively; if U_{w}≧Wₓ, generating the quantitative value responsive to a first light notification; if Wₓ>U_{w}≧W_{y} generating the quantitative value responsive to a second light notification; if W_{y}>U_{w}, generating the quantitative value responsive to a third light notification.

8. The method of claim 7, wherein the first light notification, the second light notification and the third light notification represent the order of the job priority; the first light notification is displayed as red light meaning of an urgent job required immediate supports; the second light notification is displayed as yellow light meaning of a job required close observation; and the third light notification is displayed as green light meaning of a normal job.

9. The method of claim 8, wherein saving the job data by one of the users and the subordinate staff thereof in a database server through a data saving module.

10. The method of claim 5, wherein the generation of quantitative value comprises the comparison among the weight value of U_{w} and the highest threshold value of Wₓ, the middle threshold value of W_{y} and the lowest threshold value of W_{z} respectively; if U_{w}≧Wₓ, generating the quantitative value responsive to the first light notification; if Wₓ>U_{w}≧W_{y}, generating the quantitative value responsive to the second light notification; if W_{y}>U_{w}≧W_{z}, generating the quantitative value responsive to third light notification; and if W_{z}>U_{w}, generating the quantitative value responsive to a question mark.

11. The method of claim 10, wherein the first light notification, the second light notification and the third light notification are represented the order of the job priority; the first light notification is displayed as the red light meaning of an urgent job required immediate supports; the second light notification is displayed as the yellow light meaning of a job required close observation; the third light notification is displayed as green light meaning of a normal job; and the question mark means that the user stays in idle mode.

12. The method of claim 11, wherein saving the job data by one of the users and the subordinate staff thereof in a database server by a data saving module

13. A light path management system, comprising:
a database server for saving a plurality of user's job data;
a data transmission module for providing a plurality of users to transmit data by the usage of a terminal between a network system and an operation system;
a data saving module for providing a user to save job data in the database server;
a light counting module for calculating the user's weight value in accordance with the job data and one predetermined algorithm saved in the database server, and further comparing the user's weight value with at least one predetermined threshold value to generate a quantitative value, and sequentially selecting a maximum value from quantitative values as a light-outputting value whereby the terminal displays a light notification responsive to the light-outputting value for expressing the user's working status; and
wherein the light notification is displayed in accordance with the user's job priority.

14. The system of claim 13, wherein the light notification comprises a first light notification, a second light notification, and a third light notification, as well as a question mark.

15. The system of claim 14, wherein the first light notification, the second light notification and the third light notification are represented the order of the job priority. The first light notification is displayed as red light meaning of an urgent job required immediate supports; the second light notification is displayed as yellow light meaning of a job required close observation, the third light notification is displayed as green light meaning of a normal job.

16. The system of claim 14, wherein the first light notification, the second light notification and the third light notification are represented the order of the job priority; the first light notification is displayed as red light meaning of an urgent job required immediate supports; the second light notification is displayed as yellow light meaning of a job required close observation; the third light notification is displayed as green light meaning of a normal job, and the question mark means that the user stays in idle mode.

17. The system of claim 13, wherein the database server further saves the user's identification; the light counting module further clarifies the weight value if involving with the job data of subordinate staff; if the weight value is not involved with the job data of the subordinate staff, outputting the user's quantitative value as the light-outputting value; whereas, if the weight value is involved with the job data of the subordinate, counting the weight value of the subordinate staff, and further comparing the weight value of thE subordinate staff with at least one predetermined threshold value by means of generating the quantitative value of the subordinate staff, and sequentially selecting the maximum value from quantitative values among the user and the subordinates thereof as the light-outputting value.

18. The system of claim 17, wherein the light counting module further sets the quantitative value of the subordinate staff as the light-outputting value, and respectively outputs the light-outputting value of subordinate staff whereby the terminal displays the light notification responsive to the light-outputting value of the user and the subordinate staff for expressing the working status of the user and the subordinate staff thereof.

19. The system of claim 18, wherein the light counting module further clarifies the user's weight value if more than a highest threshold value prior to calculating the individual weight value of the subordinate staff; if the weight value is more than the highest threshold value, the quantitative value of the user is set as the light-outputting value without either calculating the weight value of the subordinate staff or processing further procedures. Whereas, if the weight value is less than the highest threshold value, saving the quantitative value of the user, and sequentially calculating the weight value of subordinate staff, and then processing further procedures.

20. The system of claim 19, wherein the light notification comprises a first notification, a second light notification and a third light notification, as well as a question mark.

21. The system of claim 20, wherein the first light notification, the second light notification, and the third light notification are represented the order of the job priority. The first light notification is displayed as red light meaning of an urgent job required immediate supports; the second light notification is displayed as yellow light meaning of a job required close observation; the third light notification is displayed as green light meaning of a normal job.

22. The system of claim 20, wherein the first light notification, the second light notification and the third light notification are represented the order of the job priority; the first light notification is displayed as red light meaning of an urgent job required immediate supports; the second light notification is displayed as yellow light meaning of a job required close observation; the third light notification is displayed as green light meaning of a normal job; and the question mark means that the user stays in idle mode.

23. The system of claim 13, further comprises a data retrieving module for searching the light notification of the user, and the job data in accordance with the searched criteria inputted by the user in the system.

24. The system of claim 19, wherein further comprises a data retrieving module for searching the light notification of the user and the subordinate staff, and the job data in accordance with to the searched criteria inputted by the user in the system.

25. The system of claim 24, wherein the terminal displays the light notification in heretical order for expressing the working status of the user and the subordinate staff thereof.
